(19) United States
(12) Patent Application Publication
(10) Pub. No.: US 2014/0320894 A1
(43) Pub. Date: Oct. 30, 2014

(54) Intelligent Print Release

(71) Applicant: LEXMARK INTERNATIONAL, INC., Lexington, KY (US)

(72) Inventor: James Leonard Farthing, Lexington, KY (US)

(73) Assignee: Lexmark International, Inc., Lexington, KY (US)

(21) Appl. No.: 13/872,445

(22) Filed: Apr. 29, 2013

(51) Int. Cl. G06F 3/12

(52) U.S. Cl. CPC G06F 3/126
USPC 358/1.15

(57) ABSTRACT

A print release environment includes a print server and pluralities of imaging devices. A user of a computing device sends to the print server a current print job for imaging operations. The print server analyzes metrics of the current print job relative to prior print jobs of the same user. Before the user makes a claim to pick up the current. print job from a specific one of the imaging devices, the print server predicts where the user will likely make their claim. The print server sends the current print job to the device in advance of the user's claim to speed processing. Further embodiments note techniques for making predictions.

### FIELD OF THE INVENTION

The present invention relates to print release environments including print servers and imaging devices. It relates further to pre-staging print jobs at imaging devices before users claim them to speed processing. Methods and apparatus predict where users will make claims.

### BACKGROUND

In traditional printing environments, users send print jobs from computers, phones, tablets, etc. direct to imaging devices for printing and hard-copy pick up. In print release environments, print servers hold print jobs until later claiming by users at one of many networked imaging devices. The servers act as intermediaries between the users and devices to enforce compliance of policies. Imaging devices first authenticate users before allowing them to stake claims to their print jobs. This makes them accountable for the size, costs, quotas, etc. of their projects and prevents accidental release of hard copies to others. Managed print services (MPS) is but one popular form implementing print release with user authentication.

Regardless of form, the total time that users wait to obtain their hard copy aggregates together the time of many steps. Users first wait during the time of authentication to the device. They next wait for the device to reach a print-ready state. Simultaneously, they wait for the device to request the electronic transfer of the print job from the server and for the transfer back of the print job to the imaging device. They next wait for the imaging device to conduct image processing. Users wait last for the printing of the hard copy.

As users can claim their jobs from myriads of imaging devices connected to the print server, and that the devices may reside at locations greatly separated from the location of the server, the time to request and transfer print jobs between the server and the imaging device may be unduly long. Depending on the volume of network traffic and server loading at any given time, print jobs can sometimes take minutes to complete. What is needed is a solution that speeds the time a user waits. However, achieving quicker print-ready states and executing faster printing only yields incremental improvements in wait times so further needs in the art should contemplate eliminating or reducing the number of on-demand print job transfers in the network between the server and its interconnected imaging devices.

Reductions in user wait time could be also achieved by improving computing infrastructure, such as increasing network bandwidth, or reducing the amounts of data transferred over networks. Similarly, parties involved in making and configuring network devices could improve wait times by bettering individual devices and/or increasing server volume density thereby minimizing network and server latency. However, these alternatives require infrastructure modification/improvement and/or significant changes in data architecture which is unfeasible for many organizations. What is need is a simple, yet elegant solution. Additional benefits and alternatives are also sought when devising solutions.

### SUMMARY

The above-mentioned and other problems are solved by methods and apparatus implementing intelligent print release. A print release environment includes a print server and pluralities of imaging devices, e.g., printers, copiers, fax machines, etc. A user of a computing device sends to the print server a print job for imaging. The print server analyzes metrics of the current job relative to prior print jobs of the same user. Before the user makes a claim to pick up the current print job from a specific one of the imaging devices, the print server predicts where the user will make their claim. The print server sends the current print job to the device in advance of the user's authentication/claim to speed processing, including conducting image processing as necessary. The techniques limit the amount of time users must wait before imaging operations are complete.

Further embodiments note techniques for making predictions as well as noting computing environments, including arrangement of servers, imaging devices, etc. Controllers for making predictions are still other embodiments and are found throughout. the environment, including configuration on the server, imaging devices, or combinations thereof.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagrammatic view of a print release computing system environment for intelligent print release;

FIG. 2 is a flow chart for intelligent print release; and

FIGS. 3-5 are diagrammatic views of representative metrics useful for predicting where users will make claims to pick up hard copies of their print jobs.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, methods and apparatus teach intelligent print release.

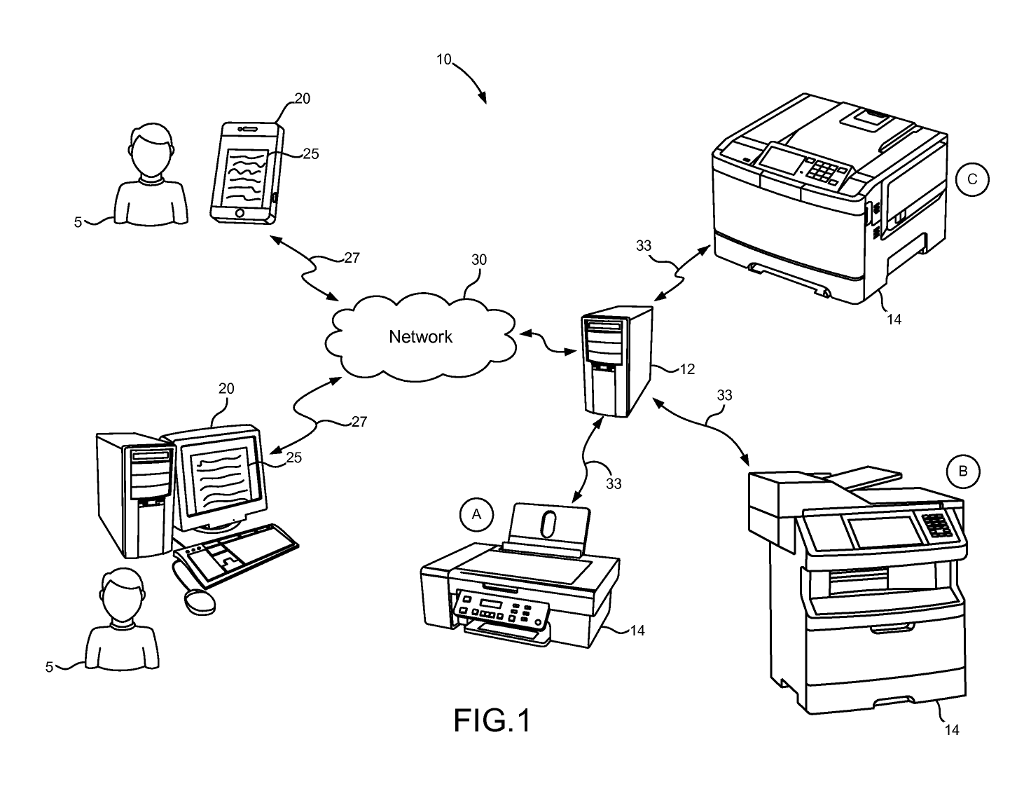

With reference to FIG. 1, a print-release computing system environment 10 includes at least one print server 12. The print server connects to pluralities of imaging devices 14. The imaging devices include, but are not limited to, printers, copiers, fax machines, all-in-ones, multi-function printers (MFPs), etc. The imaging devices are any of a variety, but labeled as Printers (A), (B) and (C) in order to illustrate below various examples of operation.

Users 5 interact with computing devices 20 such as smart phones, laptop computers, desktop computers, tablets, iPads, etc. They display and engage items 25 on the computing devices, such as documents, images, web pages, screen shots, messages, files, photos, etc. The items are in need of imaging operations, such as printing, scanning, copying, faxing, etc. Users request imaging of the items by sending 27 a “print job” to the print server 12 by way of an attendant computing network 30. The print job includes description for controllers in the various devices to speak to one another in a same page description language. The primary printer language of contemporary times includes Printer Command Language (PCL) or Postscript and skilled artisans are familiar with their content. There are other languages, however, and skilled artisans are familiar with them as well. In any language, the print server forwards 33 the print job to a specific imaging device so users can claim a hard copy output at any imaging device 14 of their choosing. The network encompasses these communications. The network includes or not a variety of software to send and receive packets of information between computing devices and physical hardware to move the packets, such as routers, servers, switches, desktop/laptop computers, phone transmission towers, relay towers, satellites, fiber optics, phone lines, cables, etc. The connections are wired and wireless communications between a few or many such devices in an internet, intranet or other environment.

To speed processing, and reduce the time users wait before picking up their hard copy, the print server 12 analyzes metrics of the print job to predict at which one of the plurality of imaging devices 14 the users will eventually stake their claim. The analysis examines the current print job of the user relative to prior print jobs of the user to determine if it can be ascertained beforehand where the user will make their claim to future imaging operations.

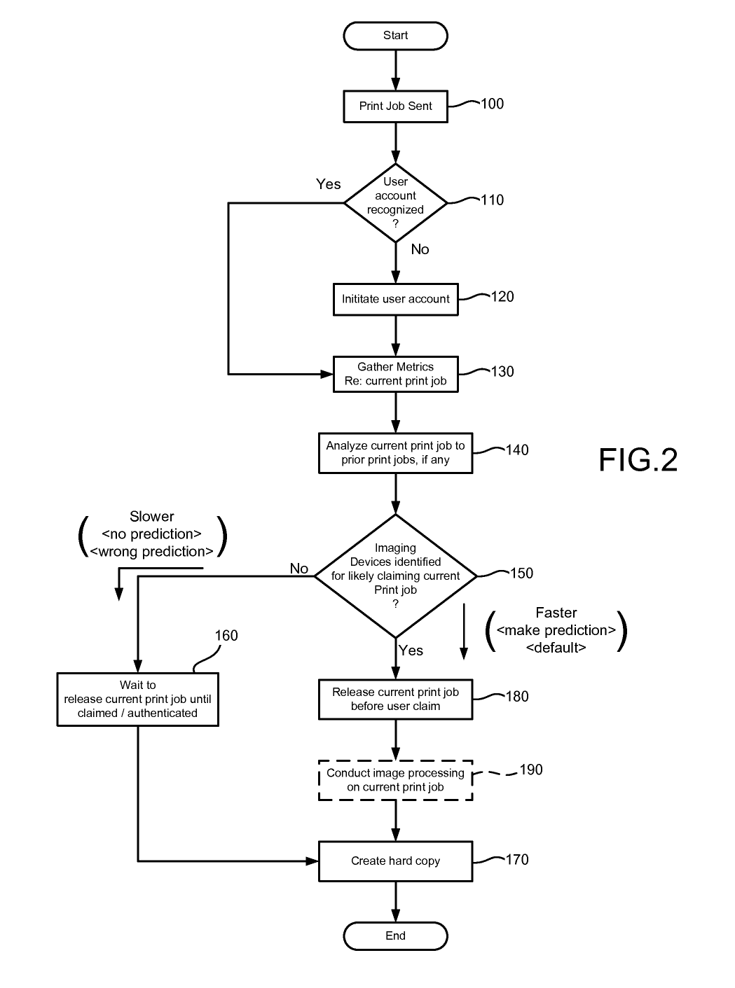

With reference to FIG. 2, users command their computing devices to send the current print job to the print server (100). Upon receipt, the server determines whether or not the user has an existing imaging account in the print release environment (110). If not, the server communicates back to the computing devices for the user to initiate an account (120) so that a history of imaging operations of the user can be created. Once done, or if earlier created, the print server gathers metrics regarding the present print job under consideration (130).

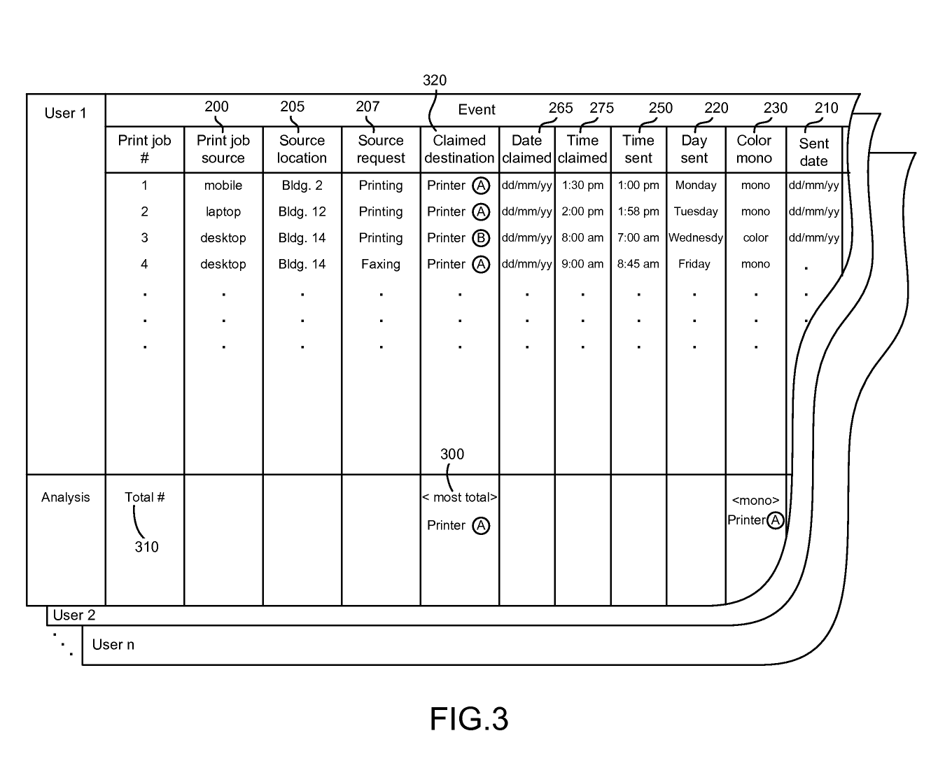

With reference to FIG. 3, some of the metric includes determining on what type of computing device the present print job originates (e.g., <print job source> 200). The print source can be a mobile device, such as a smart phone, laptop, desktop, tablet, etc. The location of the computing device can be also noted, <source location> 205, such as by a building number of an enterprise, address, geographic coordinates, etc. The type of imaging operation requested by the computing device <source request> 207 is still further recorded. This includes noting whether the user makes a claim for printing, faxing, copying, etc. In other metric, the print job has other data of interest, such as the date the print job was sent <sent date> 210, what day of the week it was sent <day sent> 220, what time of day it was sent <sent date> 250, and whether or not the imaging operation includes color or mono image processing <color mono> 230.

With reference to FIG. 2, the print server next analyzes the metrics just gathered to metrics of prior print jobs, if any (140). If this is a first-time user account, or there exists no earlier print jobs by the user, there is no historical record of earlier imaging for comparison purposes. The server then has no manner for evaluating current print jobs to prior print jobs and is unable to identify an imaging device (150) at which a user would likely make a claim to pick up their hard copy imaging proceeds thence as would be typical in a traditional print release environment. Namely, the print server holds the print job until the user logs-in or otherwise authenticates themselves at one of the imaging devices (160). Upon the user making the actual request to receive a hard copy, such as selecting “print release” or executing a similar function on the imaging device, the imaging device requests from the server the transfer of the print job and the server sends the print job. Upon receipt, the imaging device conducts image processing on the print job, such as raster image processing, and creates a hard copy for the users to pick up (170). On the other hand, if users have a history of earlier print jobs, the print server can undertake identifying at 150 where users will likely make a claim to pick up a hard copy of their print job at a particular imaging device.

With reference to FIG. 3, metrics of current print jobs are analyzed relative to prior print jobs of the user. The metrics of prior jobs are the same as current jobs, but further include items regarding the actual claiming of the print job, such as the day it was claimed <date claimed> 265, the time it was claimed <time claimed> 275, and from what imaging device it was claimed <claimed destination> 320, etc. The server draws conclusions about past behavior of the user that assist in predicting their future behavior regarding the claiming of a next print job. If policy expects users to make future claims to print jobs at their most-used imaging device and/or physically closest imaging device, the server looks for indicia of this behavior in the past print jobs to predict the future. In the example, the server notes a total number of print jobs 310 made by User 1 and where those jobs were claimed <claimed destination> 320. By ranking the imaging devices from highest-to-lowest numbers of user claims, the server knows which imaging device is used most often for claiming print jobs. As Printer (A) is used to claim three print jobs, print job #'s 1, 2, and 4, while Printer (B) is used to claim only one print job, print job 3, the server knows that Printer (A) is used more regularly than any other imaging device. It flags the printer as the <most total> 300. By comparing the <source location> 205 to known locations of the <claimed destination> 320, the server also confirms or denies whether the <most total> printer is also the physically closest printer. It then makes predictions to future claims according to the policy.

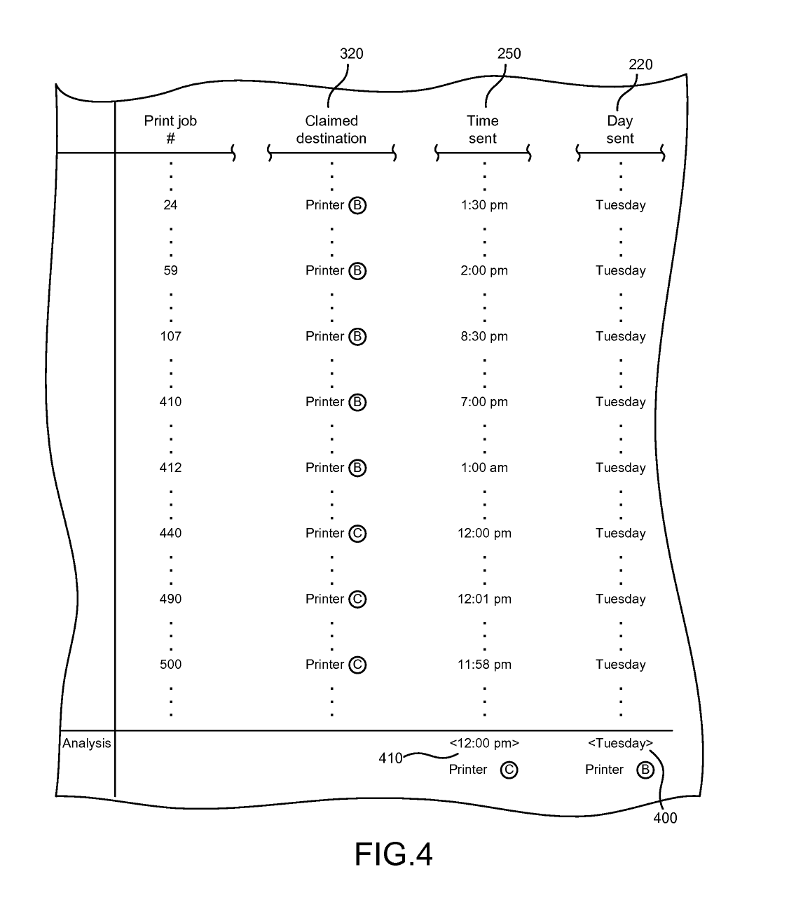

With reference to FIG. 4, the print server identifies a likely claim by a user to an imaging device based upon a particular day of the week. By noticing that some percentage of prior print jobs by a user all occur on a Tuesday <day sent> 220, the print server can identify Printer (B) 400 as the <Tuesday> imaging device having the highest number of claims made and most likely to receive a future claim on Tuesdays (compare: five Tuesday print jobs on Printer (B), #'s 24, 59, 107, 410 and 412, vs. three Tuesday print jobs on Printer (c), #'s 440, 490 and 500). However, as both Printers (B) and (C) have claims made on Tuesday, multiple variables can be used together to make better predictions for indicating future claims. For instance, the server can further note that on the times of day <time sent> 250 for imaging operations near 12:00 noon (or within a margin of tolerance, say twenty minutes <11:50-12:10>), print jobs were claimed most often by the user at Printer (C), and not Printer (B). Projecting forward, the server is free to conclude that the likeliest destination for all future print jobs on <Tuesday> near <12:00 pm> is Printer (C) 410, while at all other times On <Tuesday> it is Printer (B). Similarly, additional and other variables can be combined together to make still better predictions.

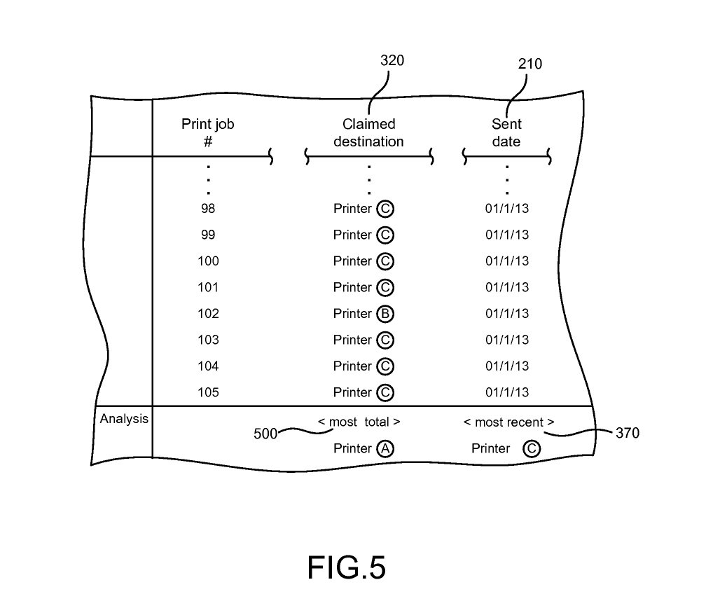

With reference to FIG. 5, the print server identifies where users will likely make a claim to a current print job according to a <most recent> 370 imaging device, say

Printer (C). By noticing that all but one print job (Print job #102) sent on Jan. 1, 2013 was claimed at Printer (C), the server can guess that a next print job sent on the same day Jan. 1, 2013, but later in time, will also be claimed at Printer (C). This can be true despite Primer (A) 500 being the claimed destination 320 still having the <most total> claims made. Of course, those skilled in the art are now able to contemplate other scenarios for analyzing metrics gathered on print jobs to make conclusions about where users will likely make claims for collecting future print jobs.

Regardless of metric, with reference to FIG. 3, the server can release the current print job to the predicted imaging device at (180) in advance of the user making an actual claim for it. In this way, the imaging device no longer needs to wait for the user to arrive to claim it, send a request back to the server, and wait to receive back the current print job. Users then need wait only for the imaging device to achieve a “print-ready” state, if not already at such a state, and the time for actually producing the hard copy during printing at (170). In some instances, users may effectively gain several minutes of productivity per each print job. To further speed processing, the imaging device can also optionally conduct image processing on the print job, such as raster image processing (190).

Appreciating the possibility that the server will predict wrongly to pre-staging the current print job at a select one of the imaging devices, the server may also retain in memory a copy of the print job it released at 180. Upon the user authenticating to another of the imaging devices not earlier predicted, the server conducts print release at 160 in a traditional sense as already described. The server also notifies the imaging device having earlier (wrongly) received the print job to release from memory its version of the print job. The imaging device confirms back to the server upon the release being complete. The server releases its copy according to policy of the organization utilizing it, such as <release upon user claim> or <release all print jobs if not claimed within twenty-four hours>.

In other policies, the organization may set forth optional items that it believes are beneficial to still faster processing of print jobs. This includes entering a default provision that releases the current print job at 180 to a <physically closest> imaging device in the event the server is unable to make a prediction or make a prediction having an acceptable level of certainty. Alternatively, policies could require that all current print jobs be pre-staged at one or more printing devices regardless of the server's ability to accurately predict. This option, however, likely requires additional memory space in the imaging devices.

In still other embodiments, skilled artisans will appreciate that users might altogether forego claiming their print jobs. In such situations, pre-staged print data at imaging devices will be released from memory after a predetermined period of time. The time could mirror that for the server, such as <release all print jobs if not claimed within twenty-four hours>. Once released, the imaging device notifies the server of the release.

In still other scenarios, the server might accurately predict users will make claims to pick up their hard copy imaging operations at 150, 180 and the imaging devices 14 will still deliver them to users at 170, but instead of immediately releasing the print data of the print job from memory, the imaging device might retain the data for another predetermined amount of time to allow users local manipulation of the print job (i.e. request for more copies, etc.). Once the print job is ultimately released from the imaging device, however, it still communicates its release back to the server to update the print queue.

The mechanism for conducting the foregoing analysis has been described as being part of the print server (12). The structure can be typified in a controller, such as an ASIC, microprocessor, etc. having executable code that extracts and analyzes the relevant metrics of current and prior print jobs. The functionality of the controller, however, can be split amongst other hardware devices, such as between the print server (12) and one or more of the imaging devices (14). Alternatively, the functionality can reside in the imaging devices (14) alone or in still other computing devices in the network (not shown).

Relative advantages of the many embodiments should now be apparent to skilled artisans. They include but are not limited to: (1) speeding time users must wait to obtain hard copies of imaging operations in print release environments; (2) predicting when and where users will make claims for imaging operations; and (3) adding redundancy so users can claim print jobs from myriads of devices located at many locations.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. A method for staging print jobs in a print release environment having a print server and pluralities of imaging devices, comprising predicting at which one of the plurality of imaging devices a user will likely make a claim for a current print job before the user who sent the current print job to the print server makes said claim at a specific one of the plurality of imaging devices in the print release environment.

2. The method of claim further including analyzing metrics of the current print job relative to prior print jobs of the user in the print release environment.

3. The method of claim 2, further including determining where the user has earlier claimed print jobs amongst the pluralities of imaging devices in the print release environment.

4. The method of claim 3, further including determining where the user has claimed a highest total of print jobs.

5. The method of claim 2, further including determining when the user has earlier claimed print jobs amongst the pluralities of imaging devices in the print release environment.

6. The method of claim 5, further including determining days or times of day the user has claimed earlier print jobs.

7. The method of claim 1, further including determining whether the current print job is likely to be claimed at a color or monochrome imaging device from amongst the pluralities of imaging devices.

8. A method for pre-staging print jobs in a print release environment having a print server and pluralities of imaging devices, comprising:
analyzing a current print job received at the print server from a user of a computing device relative to prior print jobs of the user; and
before the user makes a claim to the current print job from a specific one of the plurality imaging devices in the print release environment, predicting at which one of the plurality of imaging devices the user will likely make said claim.

9. The method of claim 8, wherein before the user makes said claim, sending the current print job from the print server to the predicted Which one of the plurality of imaging devices.

10. The method of claim 8, further including sending the current print job from the print server to a non-predicted imaging device of the plurality of imaging devices upon the predicting being wrong.

11. The method of claim 8, wherein the analyzing metrics further includes determining a highest total of earlier claimed print jobs, a most recent earlier claimed print job, an earlier claimed print job on a particular day or at a particular time, or whether the current print job is a color or monochrome print job.

12. A method for pre-staging print jobs in a print release environment having a print server and pluralities of imaging devices, comprising:
receiving at the print server a current print job from a computing device requesting an imaging operation;
analyzing metrics of the current print job relative to prior print jobs of a user of the computing device; and
before the user makes a claim to the imaging operation from a specific one of the plurality imaging devices in the print release environment,
predicting at which one of the plurality of imaging devices the user will likely make said claim, and
sending the current print job from the print server to the predicted which one of the plurality of imaging devices.

13. The method of claim 12, further including conducting image processing on the current print job after the sending from the print server but before the user makes said claim.

14. The method of claim 13, wherein the conducting image processing further includes conducting raster image processing by said predicted which one of the plurality of imaging devices.

15. The method of claim 12, further including keeping on the print server a copy of the current print job after said sending the current print job from the print server to the predicted which one of the plurality of imaging devices.

16. The method of claim 12, further including determining whether the user has any prior print jobs.

17. The method of claim 16, further including initiating a user account if the user has no prior print jobs.

18. The method of claim 12, further including releasing from the print server the current print job only after the user claims the current print job.

19. The method of claim 12, further including sending the current print job from the print server to another of the plurality of imaging devices if the predicting was wrong and the user claims the current print job from said another of the plurality of imaging devices.

20. The method of claim 19, further including releasing the current print job from said predicted which one of the plurality of imaging devices upon the predicting being wrong.
